(19) United States
(12) Patent Application Publication
(10) Pub. No.: US 2012/0200182 A1
(43) Pub. Date: Aug. 9, 2012

(54) STATOR CORE ASSEMBLY AND MOTOR INCLUDING THE SAME

(75) Inventor: Jae Woon PARK, Suwon (KR)

(73) Assignee: Samsung Electro-Mechanics Co., Ltd., Suwon (KR)

(21) Appl. No.: 13/368,780

(22) Filed: Feb. 8, 2012

(30) Foreign Application Priority Data
Feb. 8, 2011 (KR) 10-2011-0010990

(51) Int. Cl. H02K 3/28

(52) U.S. Cl. 310/71

(57) ABSTRACT

Disclosed herein are a stator core assembly and a motor including the same. The stator core assembly includes: a core back inserted into and combined with a stationary member; and one or more teeth parts protruding from the core back and having a coil wound therearound, wherein the coil is wound around a predetermined teeth part among the teeth parts, and then led out from a lower part in an axial direction of the predetermined teeth part in order to wind around another teeth part for the next winding.

### CROSS-REFERENCE TO RELATED APPLICATIONS

This application claims the priority of Korean Patent Application No. 10-2011-0010990 filed on Feb. 8, 2011, in the Korean Intellectual Property Office, the disclosure of which is incorporated herein by reference.

### BACKGROUND OF THE INVENTION

1. Field of the Invention

The present invention relates to a stator core assembly and a motor including the same, and more particularly, to a stator core assembly for minimizing defects by preventing contact between a coil wound around a stator core and a rotating member, and a motor including the same.

2. Description of the Related Art

A hard disk drive (HDD), an information storage device, reads data stored on a disk and writes data to the disk by using a read/write head.

This hard disk drive needs a disk driving device capable of driving the disk, and a small-sized motor is used therefor.

A fluid dynamic bearing assembly is used in the small-sized motor. Oil is interposed between a shaft and a sleeve to support the shaft by fluid pressure generated from the oil. Herein, the shaft is a rotating member of the fluid dynamic bearing assembly, and the sleeve is a stationary member of the fluid dynamic bearing assembly.

As for this motor, the coil is wound around the stator core multiple times in order to generate a rotational driving power. The rotational driving power of the motor is obtained by interaction between the wound coil and a magnet.

Herein, the stator core is formed by overlappingly laminating several sheets of cores, which are respectively made by pressing silicon-steel materials one by one. An insulating film is formed on the stator core, and the coil is wound around the stator core.

The stator core, around which the coil is wound, is inserted into a base member, a stationary member of the motor, thereby functioning as one constituent element of the stationary member. The rotating member including the magnet is rotated through interaction with the stator core.

In this case, when the rotating member is rotated, the rotating member comes into contact with the coil wound around the stator core by various factors including external impacts or the like, and thus may lead to generation of defects, such as short circuits. This is recognized as an important matter directly linked to an operation of the motor.

Therefore, in winding the coil around the stator core, research into an improvement in performance and an extension of the lifespan of the motor by preventing contact between the coil and the rotating member is urgently required.

### SUMMARY OF THE INVENTION

The present invention provides a stator core assembly having enhanced performance and lifespan by improving a winding pattern of a coil to prevent contact between the coil and a rotating member including a hub when winding the coil around a stator core, and a motor including the same.

According to an aspect of the present invention, there is provided a stator core assembly, including: a core back inserted into and combined with a stationary member; and one or more teeth parts protruding from the core back and having a coil wound therearound, wherein the coil is wound around a predetermined teeth part among the teeth parts, and then led out from a lower part in an axial direction of the predetermined teeth part in order to wind around another teeth part for the next winding.

The coil led out from the lower part in the axial direction of the predetermined teeth part may be extended to a lower part in an axial direction of a neighboring teeth part, and then extended to an upper part in an axial direction of a teeth part adjacent to the neighboring teeth part.

The coil led out from the lower part in the axial direction of the predetermined teeth part may be extended to an upper part in an axial direction of a neighboring teeth part, and then extended to a lower part in an axial direction of a teeth part adjacent to the neighboring teeth part.

The coil led out from the lower part in the axial direction of the predetermined teeth part may be led in to a lower part in an axial direction of another teeth part for the next winding, and wound around the teeth part for the next winding.

The coil may be wound around the predetermined teeth part and another teeth part for the next winding in a counterclockwise or a clockwise direction.

The coil may be wound around the teeth parts while moving to the teeth parts in a counterclockwise or a clockwise direction based on an upper part of the core back.

The number of the teeth parts may be 3N (where N is a natural number), while the teeth parts are spaced apart at the same pitch interval with respect to the core back, and the coil is a 3-phase coil; and common portions as one ends of phase coils of the 3-phase coil may be led out from the same slot.

According to another aspect of the present invention, there is provided a motor, including: a stator core assembly in which a coil is wound; and a rotating member combined with the stationary member, the rotating member being capable of rotating with respect to the stationary member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor including a stator core assembly according to an exemplary embodiment of the present invention;

FIG. 2 is a schematic perspective view showing a stator core provided in a stator core assembly according to an exemplary embodiment of the present invention;

FIG. 3 is a bottom view showing a stator core assembly according to an exemplary embodiment of the present invention;

FIG. 4 is a side view showing a stator core assembly according to an exemplary embodiment of the present invention;

FIGS. 5A through 5C are schematic diagrams, respectively showing a winding pattern of a coil, in which the coil is wound around respective teeth parts of a stator core arranged on a plane according to an exemplary embodiment of the present invention;

FIGS. 6A through 6C are schematic diagrams, respectively showing a winding pattern of a coil, in which the coil is wound around respective teeth parts of a stator core arranged on a plane according to another exemplary embodiment of the present invention;

FIGS. 7A through 7C are schematic diagrams, respectively showing a winding pattern of a coil in which the coil is wound around respective teeth parts of a stator core arranged on a plane according to another exemplary embodiments of the present invention; and

FIGS. 8A through 8C are schematic diagrams, respectively showing a winding pattern of a coil, in which the coil is wound around respective teeth parts of a stator core arranged on a plane according to another exemplary embodiments of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. While those skilled in the art could readily devise many other varied embodiments that incorporate the teachings of the present invention through the addition, modification or deletion of elements, such embodiments may fall within the scope of the present invention.

The same or equivalent elements are referred to by the same reference numerals throughout the specification.

Hereinafter, the preferred embodiments of the present invention will be described in detail with reference to the accompanying drawings.

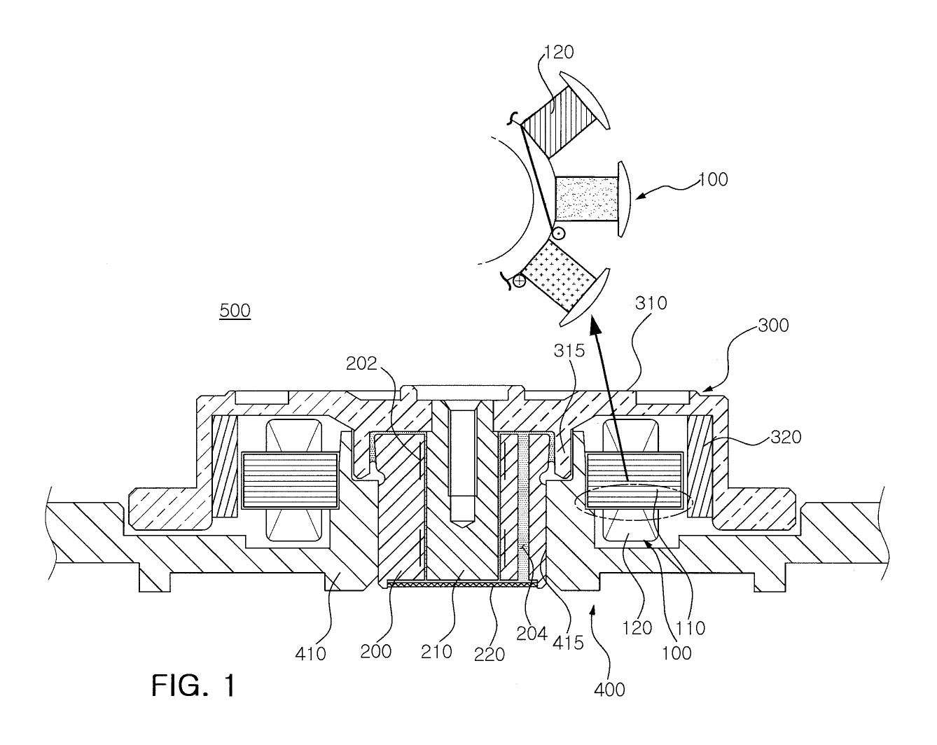

FIG. 1 is a schematic cross-sectional view showing a motor including a stator core assembly according to an exemplary embodiment of the present invention.

Referring to FIG. 1, a motor 500 including a stator core assembly 100 according to an exemplary embodiment of the present invention may include a sleeve 200 supporting a shaft 210, a rotating member 300 including a hub 310, and a stationary member 400 including a stator core 110.

First, terms related to direction will be defined. An upper part or a lower part in an axial direction may mean an upper region or a lower region based on the shaft 210 or the stator core 110, when viewed in FIG. 1.

The sleeve 200 may be one constituent element of the stationary member 400, which supports the shaft 210 such that an upper end of the shaft 210 under rotation may be protruded to an upper part thereof in an axial direction. The sleeve 200 may be formed by forging Cu or Al, or sintering Cu—Fe based alloy powder or SUS based powder.

Herein, the shaft 210 may be inserted into the sleeve 200 in such a manner that a micro-gap is generated between the shaft 210 and an axial hole of the sleeve 200. The micro-gap may be filled with oil, whereby the rotation of the rotating member 300 including the hub 310 can be smoothly supported by a radial dynamic pressure groove 202 formed on at least one of an outer diameter surface of the shaft 210 and an inner diameter surface of the sleeve 200.

The sleeve 200 may be provided with a circulation hole 204 allowing an upper portion and a lower portion of the sleeve 200 to be communicated with each other. The circulation hole 204 may enable a balance in pressure to be maintained by dispersing the pressure of oil inside the motor 500 according to the exemplary embodiment of the present invention, and may enable bubbles or the like existing inside the motor 500 to be discharged through circulation.

Herein, a cover plate 220 may be combined with the sleeve 200 at a lower part in an axial direction of the sleeve 200 while a gap between the cover plate 220 and the sleeve 200 is maintained. Herein, oil may be contained in the gap between the cover plate 220 and the sleeve 200.

As such, since the oil is contained in the gap between the cover plate 220 and the sleeve 210, the cover plate 220 may function as a bearing supporting a lower surface of the shaft 210, as it is.

In addition, the oil may continuously fill the gap between the shaft 210 and the sleeve 200, a gap between the hub 310 to be described later, and the sleeve 200, and a gap between the cover plate 220 and the shaft 210, and the sleeve 200, thereby forming a full-fill structure entirely.

The rotating member 300 including the hub 310 may be a rotational structure rotatably provided with respect to the stationary member 400 to be described later. The rotating member may include an annular ring type magnet 320 provided on an inner peripheral surface thereof, the annular ring type magnet 320 corresponding to the stator core 110 while having a constant space therebetween.

Further, the hub 310 may allow the oil to be sealed between the hub 310 and an outer surface of an upper portion of the sleeve 200. The hub 310 may have a wall portion 315 extended to a lower part in an axial direction thereof for the sealing of the oil. That is, the wall portion 315 is protruded from one surface of the hub 310, the rotating member so that the oil may be sealed between the wall portion 315 and the sleeve 200, the stationary member. The wall portion may be extended along an outer surface of the sleeve 200, the stationary member such that an interface of the oil may be formed between the wall portion and the outer surface of the upper portion of the sleeve 200, the stationary member.

The stationary member 400 including the stator core 110 may be a constituent element including the base member 410. The stator core 110 maybe combined with the base member 410.

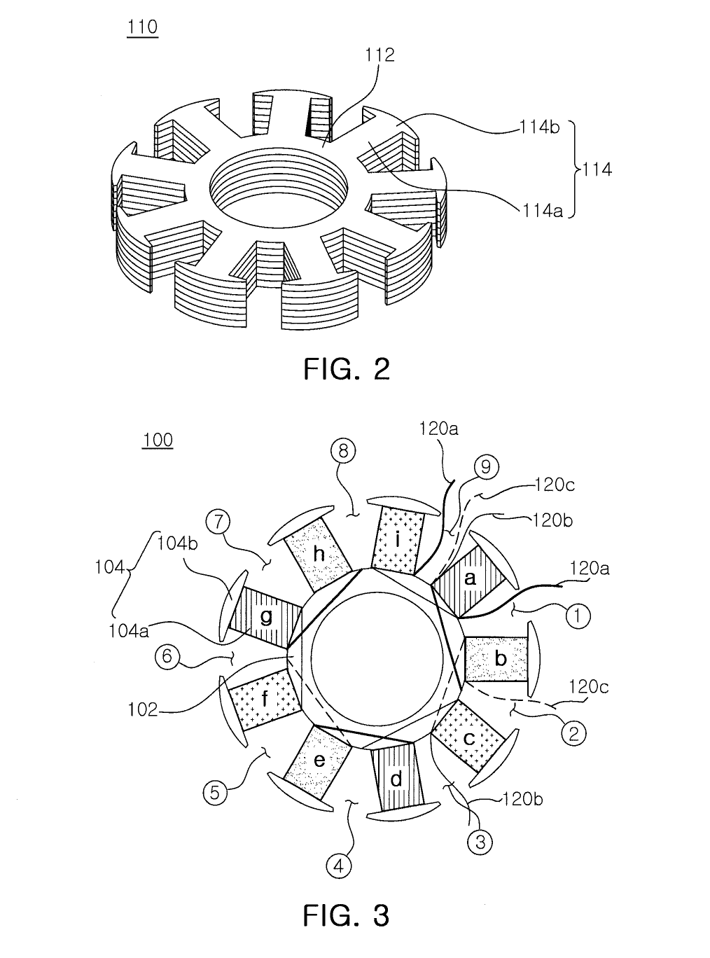

The coil 120 may be wound around the stator core 110 to form a stator core assembly 100. A winding pattern of the coil 120 will be described in detail with reference to FIGS. 2 through 6.

An exploded view in FIG. 1 shows a lower surface of the stator core assembly 100. Referring to the exploded view in FIG. 1, a bypassing line of the coil 120 is disposed on the lower surface of the stator core 110, that is, at a lower part in an axial direction of the stator core 110, whereby contact between the bypassing line of the coil 120 and the hub 310 may be prevented.

The bypassing line of the coil 120 will be in detail described with reference to FIGS. 2 through 6.

The base member 410 may be fixed to an outer peripheral surface of the sleeve 200. The stator core 110 around which the coil 120 is wound may be inserted into the base member 410. An adhesive may be applied to an inner surface of the base member 410 or an outer surface of the sleeve 200 to achieve an assembling process.

The stator core assembly 100 maybe fixedly disposed above the base member 410 including a printed circuit board (not shown) on which pattern circuits are printed. A plurality of coil holes having a certain size may be formed in an upper surface of the base member 410 corresponding to the coil 120 to expose lead-out lines of the coil 120 downwardly.

Herein, the coil 120 may be a 3-phase coil, and for convenience, may be known as a u-phase coil, a v-phase coil, and a w-phase coil, respectively.

Respective one ends of the u-phase coil, the v-phase coil, and the w-phase coil may be common portions. The respective common portions pass through the same coil hole. The other ends of the u-phase coil, the v-phase coil, and the w-phase coil may be electrically connected to the printed circuit board (not shown) by passing through different coil holes so that external power may be supplied.

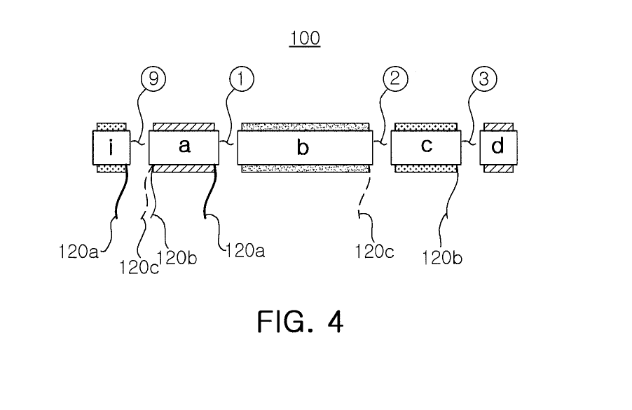

FIG. 2 is a schematic perspective view showing a stator core provided in a stator core assembly according to an exemplary embodiment of the present invention. FIG. 3 is a bottom view showing a stator core assembly according to an exemplary embodiment of the present invention. FIG. 4 is a side view showing a stator core assembly according to an exemplary embodiment of the present invention.

Referring to FIG. 2, a stator core 110 provided in a stator core assembly according to an exemplary embodiment of the present invention may be formed by laminating several sheets of cores one by one.

The sheet of core may be formed by pressing a silicon-steel material. The stator core 110 may be formed by overlappingly laminating several sheets of these cores.

The stator core 110 may include a core back 112 combined with the base member 410, the stationary member 400, and one or more teeth parts 114 protruded from the core back 112.

In addition, an opening may be formed in the core back 112 in order to allow the core back 112 to be combined with and fixed to the base member 410, the stationary member 400. The opening may be, for example, disposed in the center of the core back 112.

In addition, the core back 112 may be formed to have a ring shape, but the shape of the core back 112 and the position of the opening thereof are not limited thereto, and may be variously modified.

That is, the core back 112 may be modified to have various shapes, such as a square ring shape, a hexagonal ring shape, an octagonal ring shape, and the like, according to the shape of a protruded outer periphery 415 (see FIG. 1) of the base member 410.

The teeth parts 114 may be protruded from the core back 112 in an outer diameter direction of the core back 112. A coil 120 may be wound around the teeth parts 114 to allow for the inflow of magnetic flux of the magnet 320.

In other words, the number of teeth parts 114 may be 3n (where n is natural number) due to the nature of the wound 3-phase coil 120 while the teeth parts 114 are spaced apart from each other at the same pitch interval with respect to the core back 112.

Herein, as for slots, each slot refers to a space between the teeth parts 114. The number of slots may be the same as the number of teeth parts 114.

Herein, each of the teeth parts 114 may include an end portion 114B, which defines an outside end of the teeth part 114 in the outer diameter direction, and a body portion 114A, which defines the length of the teeth part 114.

Herein, the end portion 114B may have a rounded outside surface such that the entire shape of the stator core 110 forms a ring shape.

The body portion 114A, as shown in FIG. 2, may have a certain width. However, the body portion 114A is not limited thereto, and may be variously changeable.

Referring to FIGS. 3 and 4, the coil 120 may be wound around the body portion 114A of the teeth part 114, and the coil 120 may be a 3-phase coil.

That is, a motor 500 according to the exemplary embodiment of the present invention may be a 3-phase driving motor, and respective phases may be a u-phase, a v-phase, and a w-phase, as described above.

Each phase of coil 120 may be wound around the teeth part 114 while having a constant space, and led out from a lower part in an axial direction of the teeth part 114 in order to wind around another teeth part 114 for the next winding.

In other words, each phase of the coil 120 may be wound around a predetermined teeth part 114, followed by skipping two teeth parts 114, and may then be wound around the next teeth part 114.

This is due to winding of the 3-phase coil 120, and the teeth parts 114 around each of which the coil 120 of each phase is wound may be disposed adjacently to each other.

First, a winding type in which a u-phase coil 120A is wound will be described. The u-phase coil 120A may pass through a slot #1 from a lower part in an axial direction thereof, and be wound around a teeth part #a m times (where, m is a natural number of 2 or more) in a counterclockwise direction.

When the winding of m times is completed, a lead-out line of the u-phase coil 120A may pass through a slot #9, and may be led out to a lower part in an axial direction of the teeth part #a. In succession, the lead-out line of the u-phase coil 120A may pass through a lower part of in an axial direction of a teeth part #b, and be extended to an upper part in an axial direction of a teeth part #c.

The extended u-phase coil 120A may pass through a slot #3 from an upper part to a lower part in an axial direction thereof, and then be wound around a teeth part for the next winding, that is, a teeth part #d in a counterclockwise direction k times (where k is a natural number of 2 or more).

In addition, the u-phase coil 120A may be wound around a teeth part #g in the same manner as detailed above, and finally an end of the u-phase coil 120A may be led out to a lower part in an axial direction of a slot #9.

That is, a common portion of the u-phase coil 120A, which is one end of the u-phase coil 120A, may be led out to the lower part in the axial direction of the slot #9. The other end of the u-phase coil 120A may be led out to the lower part of the axial direction of the slot #1. Then, both ends of the u-phase coil 120A may respectively pass through the coil holes formed in the base member 410, and may be electrically connected to a printed circuit board (not shown) in order to receive external power.

A v-phase coil 120C and a w-phase coil 120B, may also be wound around the teeth parts 114, like the u-phase coil 120A. The common portions, which are one ends of the v-phase coil 120C and the w-phase coil 120B, may also be led out to the lower part in the axial direction of the slot #9, like the common portion of the u-phase coil 120A, and the other ends of the v-phase coil 120C and the w-phase coil 120B may be respectively led out to the lower part in the axial direction of the slot #3 and a lower part in an axial direction of a slot #2.

The base member 410 may have four coil holes, through which lead-out lines of the 3-phase coil 120 pass. Three common portions led out through the slot #9 pass through one coil hole, and the other ends opposite to the common portions may be divided into and pass through three coil holes, respectively.

Herein, the bypassing line of the coil 120 mentioned with reference to FIG. 1 may refer to a line that continually bypasses upper portions or lower portions in axial directions of teeth parts 114 located between predetermined teeth parts 114 around which the coil is wound while having a certain distance.

Therefore, the bypassing line of the 3-phase coil 120 may be formed on a lower surface in the axial direction of the stator core 110 as shown in FIG. 2.

That is, for example, in the u-phase coil 120A, a lead-out line after being wound around the teeth part #a may pass through the lower part in the axial direction of the teeth part #a, and continually pass through the lower part in the axial direction of the teeth part #b. As a result, the bypassing line of the u-phase coil 120A may be positioned at the lower part in the axial direction of the stator core 110 according to an exemplary embodiment of the present invention.

The bypassing lines of the v-phase coil 120C and the w-phase coil 120B may be positioned at the lower part in the axial direction of the stator core 110, like the u-phase coil 120A.

Therefore, in the stator core assembly 100 according to an exemplary embodiment of the present invention, since the bypassing line of the wound coil 120 is disposed at the lower part in the axial direction of the stator core 110, the possibility in which the coil 120 comes into contact with the hub 310 positioned above the stator core 110 may be excluded.

In other words, the bypassing line of the coil 120 may become loose due to various causes such as external impacts or the like. However, in the present invention, the bypassing line of the coil 120 is positioned at the lower part in the axial direction, thereby preventing contact with the hub 310.

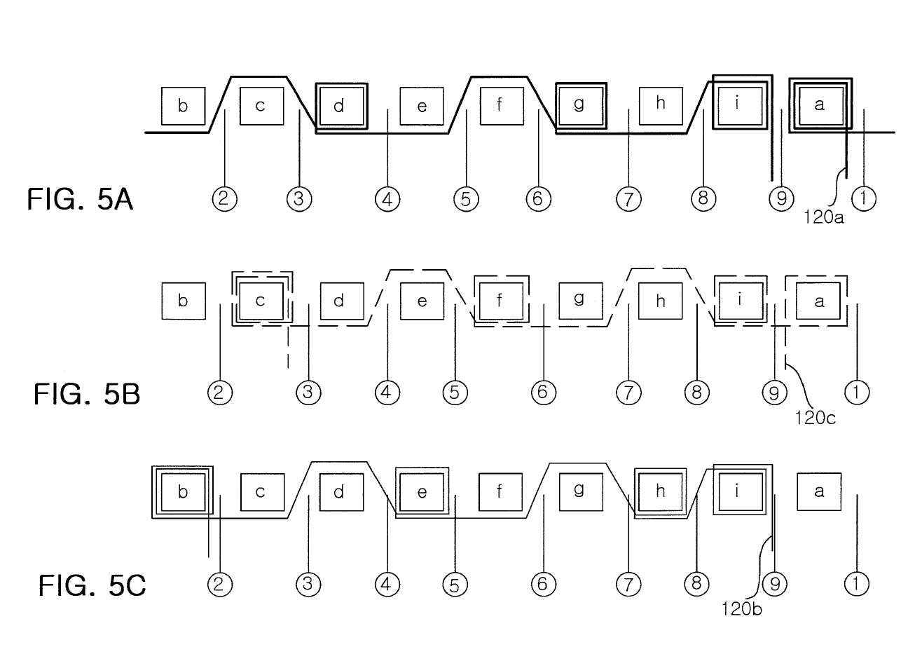

FIGS. 5A through 5C are schematic diagrams, respectively showing a winding pattern of a coil, in which the coil is wound around respective teeth parts of a stator core arranged on a plane according to an exemplary embodiment of the present invention.

First, as for a winding pattern of a u-phase coil 120A with reference to FIG. 5A, the u-phase coil 120A may be wound around a body portion 114A of a teeth part 114 while having a constant space therebetween. In particular, the u-phase coil 120A may be led in from a lower part in an axial direction of a slot #1, and wound around a teeth part #a multiple times in a counterclockwise direction.

After being wound around the teeth part #a multiple times, the u-phase coil 120A may be led out to a lower part in an axial direction of the teeth part #a, extended to a lower part in an axial direction of a teeth part #b adjacent to the teeth part #a, and extended to an upper part in an axial direction of a teeth part #c in order to wind around a teeth part for the next winding, that is, a teeth part #d.

The u-phase coil 120A extended to the upper part in the axial direction of the teeth part #c may be extended to a lower part in an axial direction of the teeth part #d, and wound around the teeth part #d multiple times in a counterclockwise direction.

The u-phase coil 120A may be wound around a teeth part #g in the same manner as detailed above. The u-phase coil 120A may be again led out from a lower part in an axial direction of the teeth part #g, pass through a lower part in an axial direction of a teeth part #h adjacent to the teeth part #g, led in to an upper part in an axial direction of a teeth part #i, wound around the teeth part #i in a clockwise direction, and then finally led out to a lower part in an axial direction of a slot #9.

Next, as for a winding pattern of a v-phase coil 120C with reference to FIG. 5B, the v-phase coil 120C may be led in to a lower part in an axial direction of a slot #3, and wound around the teeth part #c multiple times in a counterclockwise direction.

After being wound around the teeth part #c multiple times, the v-phase coil 120C may be led out to a lower part in the axial direction of the teeth part #c, extended to a lower part in an axial direction of the teeth part #d adjacent to the teeth part #c, and extended to an upper part in an axial direction of a teeth part #e in order to wind around a teeth part for the next winding, that is, a teeth part #f.

The v-phase coil 120C extended to the upper part in the axial direction of the teeth part #e may be extended to a lower part in an axial direction of the teeth part #f, and wound around the teeth part #f multiple times in a counterclockwise direction.

The v-phase coil 120C may be wound around the teeth part #i in the same manner as detailed above. The v-phase coil 120C may be again led out from a lower part in the axial direction of the teeth part #i, led in to the lower part in the axial direction of the teeth part #a adjacent to the teeth part #i, wound around the teeth part #a in a clockwise direction, and then finally led out to the lower part in the axial direction of the slot #9.

Finally, as for a winding pattern of a w-phase coil 120B with reference to FIG. 5C, the w-phase coil 120B may be led in from a lower part in an axial direction of a slot #2, and wound around the teeth part #b multiple times in a counterclockwise direction.

After being wound around the teeth part #b multiple times, the w-phase coil 120B may be led out to the lower part in the axial direction of the teeth part #b, extended to the lower part in the axial direction of the teeth part #c adjacent to the teeth part #b, and extended to an upper part in the axial direction of the teeth part #d in order to wind a teeth part for next winding, that is, the teeth part #e.

The w-phase coil 120C extended to the upper part in the axial direction of the teeth part #d may be extended to a lower part in the axial direction of the teeth part #e, and wound around the teeth part #e multiple times in a counterclockwise direction.

The w-phase coil 120B may be wound around the teeth part #h in the same manner as detailed above. The w-phase coil 120B may be again led out from the lower part in the axial direction of the teeth part #h, led in to the upper part in the axial direction of the teeth part #1 adjacent to the teeth part #h, wound around the teeth part #1 in a clockwise direction, and then finally led out to the lower part in the axial direction of the slot #9.

Herein, the common portions of the u-phase, v-phase, and w-phase coils 120A, 120C, and 120B, which are one ends of the respective phase coils, may be led out to the lower part in the axial direction of the same slot, that is, the slot #9. The other ends of the u-phase, v-phase, and w-phase coils 120A, 120C, and 120B may be respectively led out to the lower parts in the axial directions of the slots #1, #3, and #2.

In addition, it can be seen that all of the bypassing lines of the u-phase, v-phase, and w-phase coils 120A, 120C, and 120B may be formed at the lower part in the axial direction of the stator core 110. As a result, short-circuits due to contact between the bypassing line of the coil 120 and the hub 310 under rotation may be prevented in advance.

6A through 6C are schematic diagrams, respectively showing a winding pattern of a coil, in which the coil is wound around respective teeth parts of a stator core arranged on a plane according to another exemplary embodiment of the present invention.

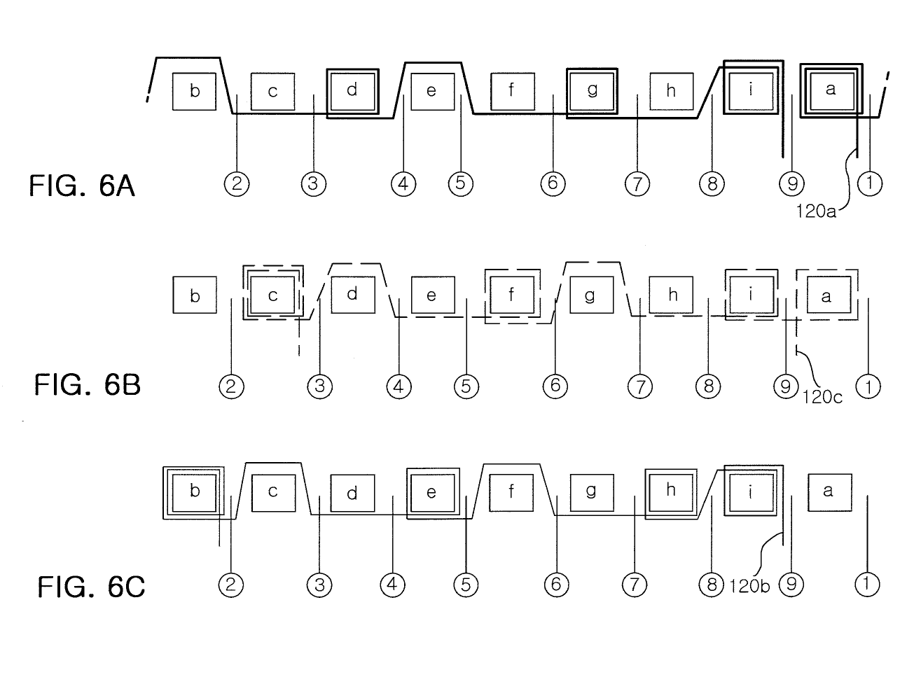

First, as for a winding pattern of a u-phase coil 120A with reference to FIG. 6A, the u-phase coil 120A may be wound around a body portion 114A of a teeth part 114, while having a constant space. In particular, the u-phase coil 120A may be led in from a lower part in an axial direction of a slot #1, and wound around a teeth part #a multiple times in a counterclockwise direction.

After being wound around the teeth part #a multiple times, the u-phase coil 120A may be led out from a lower part in an axial direction of the teeth part #a, extended to an upper part in an axial direction of a teeth part #b adjacent to the teeth part #a, and extended to a lower part in an axial direction of a teeth part #c in order to wind around a teeth part for the next winding, that is, a teeth part #d.

The u-phase coil 120A extended to the lower part in the axial direction of the teeth part #c may be led in to a lower part in an axial direction of the teeth part #d, and wound around the teeth part #d multiple times in a counterclockwise direction.

The u-phase coil 120A may be wound around a teeth part #g in the same manner as detailed above. The u-phase coil 120A may be again led out from a lower part in an axial direction of the teeth part #g, pass through a lower part in an axial direction of a teeth part #h adjacent to the teeth part #g, again led in to an upper part in an axial direction of a teeth part #i, wound around the teeth part #1 in a clockwise direction, and then finally led out to a lower part in an axial direction of a slot #9.

Next, as for a winding pattern of a v-phase coil 120C with reference to FIG. 6B, the v-phase coil 120C may be led in from a lower part in an axial direction of a slot #3, and wound around the teeth part #c multiple times in a counterclockwise direction.

After being wound around the teeth part #c multiple times, the v-phase coil 120C may be led out from the lower part in the axial direction of the teeth part #c, extended to an upper part in the axial direction of the teeth part #d adjacent to the teeth part #c, and extended to a lower part in an axial direction of a teeth part #e in order to wind around a teeth part for the next winding, that is, a teeth part #f.

The v-phase coil 120C extended to the lower part in the axial direction of the teeth part #e may be led in to a lower part in an axial direction of the teeth part #f, and wound around the teeth part #f multiple times in a counterclockwise direction.

The v-phase coil 120C may be wound around the teeth part #i in the same manner as detailed above. The v-phase coil 120C may be again led out from a lower part in the axial direction of the teeth part #i, led in to the lower part in the axial direction of the teeth part #a adjacent to the teeth part #i, wound around the teeth part #a in a counterclockwise direction, and then finally led out to the lower part in the axial direction of the slot #9.

Finally, as for a winding pattern of a w-phase coil 120B with reference to FIG. 6C, the w-phase coil 120B may be led in from a lower part in an axial direction of a slot #2, and wound around the teeth part #b multiple times in a counterclockwise direction.

After being wound around the teeth part #b multiple times, the w-phase coil 120B may be led out from a lower part in the axial direction of the teeth part #b, extended to an upper part in the axial direction of the teeth part #c adjacent to the teeth part #b, and then extended to the lower part in the axial direction of the teeth part #d in order to wind around a teeth part for the next winding, that is, the teeth part #e.

The w-phase coil 120B extended to the lower part in the axial direction of the teeth part #d may be led in to the lower part in the axial direction of the teeth part #e, and wound around the teeth part #e multiple times in a counterclockwise direction.

The w-phase coil 120B may be wound around the teeth part #h in the same manner as detailed above. The w-phase coil 120B may be again led out from the lower part in the axial direction of the teeth part #h, led in to the upper part in the axial direction of the teeth part #i adjacent to the teeth part #h, wound around the teeth part #i in a clockwise direction, and then finally led out to the lower part in the axial direction of the slot #9.

Herein, one ends of the u-phase, v-phase, and w-phase coils 120A, 120C, and 120B may be common portions, likewise in the above embodiments, and maybe led out to the lower part in the axial direction of the same slot, that is, the slot #9. The other ends of the u-phase, v-phase, and w-phase coils 120A, 120C, and 120B may be respectively led out to the lower parts in the axial directions of the slots #1, #3, and #2.

In addition, it can be recognized that all of the bypassing lines of the u-phase, v-phase, and w-phase coils 120A, 120C, and 120B may be formed at the lower part in the axial direction of the stator core 110. As a result, short-circuits due to contact between the bypassing line of the coil 120 and the hub under rotation 310 may be prevented in advance.

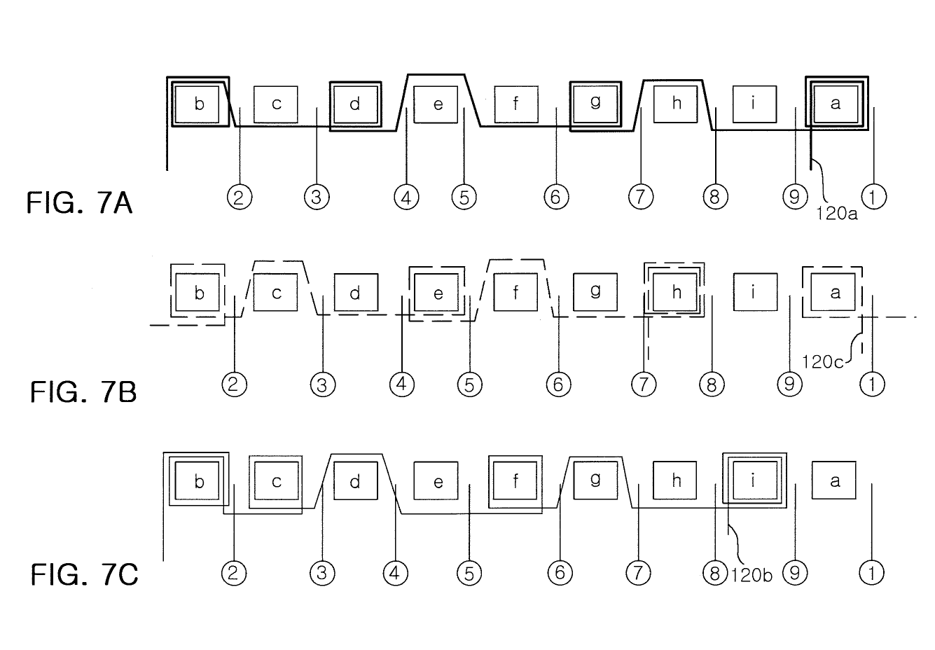

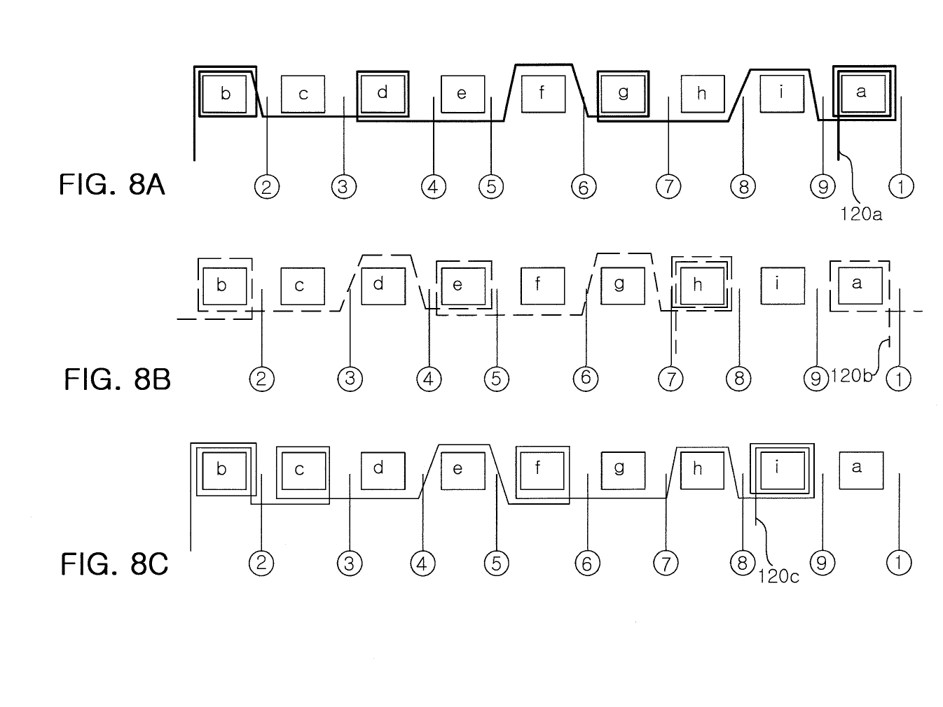

FIGS. 7A through 7C are schematic diagrams, respectively showing a winding pattern of a coil in which the coil is wound around respective teeth parts of a stator core arranged on a plane according to another exemplary embodiments of the present invention. FIGS. 8A through 8C are schematic diagrams, respectively showing a winding pattern of a coil, in which the coil is wound around respective teeth parts of a stator core arranged on a plane according to another exemplary embodiments of the present invention.

Referring to FIGS. 7A through 7C and FIGS. 8A through 8C, the coil 120 may be wound around the stator core 110 while moving to the teeth parts 114 in a clockwise direction based on an upper surface of the stator core 110.

The winding types according to exemplary embodiments shown in FIGS. 7 and 8 are the same as those according to the above embodiments described with reference to FIGS. 5 and 6, and winding directions are only different.

Herein, even though the u-phase, v-phase, and w-phase coils 120A, 120C, and 120B are wound in a clockwise direction based on the upper surface of the stator core 110, the common portions as one ends of the u-phase, v-phase, and w-phase coils may be led out from the same slot, and the other ends of the u-phase, v-phase, and w-phase coils may be led out from different slots.

A stator core and a motor including the same according to the exemplary embodiments of the present invention could prevent contact between a coil wound around the stator core and a rotating member including a hub, thereby minimizing short circuits.

In addition, according to the exemplary embodiments of the present invention contact between the coil and the rotating member could be prevented to thereby avoid noise and vibrations generated due to the contact, whereby the performance and lifespan of the motor could be maximized.

The present invention has been shown and described in connection with the exemplary embodiments, but it will be apparent to those skilled in the art that modifications and variations can be made without departing from the spirit and scope of the invention as defined by the appended claims.

What is claimed is:

1. A stator core assembly, comprising:
a core back inserted into and combined with a stationary member; and
one or more teeth parts protruding from the core back and having a coil wound therearound,
wherein the coil is wound around a predetermined teeth part among the teeth parts, and then led out from a lower part in an axial direction of the predetermined teeth part in order to wind around another teeth part for the next winding.

2. The stator core assembly of claim 1, wherein the coil led out from the lower part in the axial direction of the predetermined teeth part is extended to a lower part in an axial direction of a neighboring teeth part, and then extended to an upper part in an axial direction of a teeth part adjacent to the neighboring teeth part.

3. The stator core assembly of claim 1, wherein the coil led out from the lower part in the axial direction of the predetermined teeth part is extended to an upper part in an axial direction of a neighboring teeth part, and then extended to a lower part in an axial direction of a teeth part adjacent to the neighboring teeth part.

4. The stator core assembly of claim 1, wherein the coil led out from the lower part in the axial direction of the predetermined teeth part is led in to a lower part in an axial direction of another teeth part for the next winding, and wound around the teeth part for the next winding.

5. The stator core assembly of claim 1, wherein the coil is wound around the predetermined teeth part and another teeth part for the next winding in a counterclockwise or a clockwise direction.

6. The stator core assembly of claim 1, wherein the coil is wound around the teeth parts while moving to the teeth parts in a counterclockwise or a clockwise direction based on an upper part of the core back.

7. The stator core assembly of claim 1, wherein a number of the teeth parts is 3N (where N is a natural number), while the teeth parts are spaced apart at the same pitch interval with respect to the core back, and the coil is a 3-phase coil,
and common portions as one ends of phase coils of the 3-phase coil are led out from the same slot.

8. A motor, comprising:
the stator core assembly according to claim 1; and
a rotating member combined with the stationary member, the rotating member being capable of rotating with respect to the stationary member.
